(19) United States
(12) Patent Application Publication
(10) Pub. No.: US 2021/0051523 A1
(43) Pub. Date: Feb. 18, 2021

(54) Method, Apparatus and Computer Program for Modification of Admission Control Criteria

(71) Applicant: Nokia Solutions and Networks Oy, Espoo (FI)

(72) Inventors: Anand BEDEKAR, Glenview, IL (US); Shivanand KADADI, Bangalore (IN)

(21) Appl. No.: 16/964,428

(22) PCT Filed: Jan. 14, 2019
(86) PCT No.: PCT/EP2019/050772

§ 371 Date: Jul. 23, 2020

(30) Foreign Application Priority Data
Jan. 25, 2018 (IN) 201841003055

(51) Int. Cl. H04W 28/16; H04W 24/10; H04W 24/02; H04W 88/12; H04W 88/08

(52) U.S. Cl. CPC H04W 28/16; H04W 24/10; H04W 88/08; H04W 88/12; H04W 24/02

(57) ABSTRACT

A method including providing admission control information from a radio access node to a controller of the radio access node; and in response to the providing admission control information, receiving from the controller information including an instruction for the radio access node to modify admission control criteria of the radio access node; and modifying the admission control criteria in response to the instruction.

### FIELD

This disclosure relates to communications, and more particularly to admission control in a wireless communication system.

### BACKGROUND

A communication system can be seen as a facility that enables communication between two or more devices such as user terminals, machine-like terminals, base stations and/or other nodes by providing communication channels for carrying information between the communicating devices. A communication system can be provided for example by means of a communication network and one or more compatible communication devices. The communication may comprise, for example, communication of data for carrying data for voice, electronic mail (email), text message, multimedia and/or content data communications and so on. Non-limiting examples of services provided include two-way or multi-way calls, data communication or multimedia services and access to a data network system, such as the Internet.

In a wireless system at least a part of communications occurs over wireless interfaces. Examples of wireless systems include public land mobile networks (PLMN), satellite based communication systems and different wireless local networks, for example wireless local area networks (WLAN). A local area wireless networking technology allowing devices to connect to a data network is known by the tradename WiFi (or Wi-Fi). WiFi is often used synonymously with WLAN. The wireless systems can be divided into cells, and are therefore often referred to as cellular systems. A base station provides at least one cell.

A user can access a communication system by means of an appropriate communication device or terminal capable of communicating with a base station. Hence nodes like base stations are often referred to as access points. A communication device of a user is often referred to as user equipment (UE). A communication device is provided with an appropriate signal receiving and transmitting apparatus for enabling communications, for example enabling communications with the base station and/or communications directly with other user devices. The communication device can communicate on appropriate channels, e.g. listen to a channel on which a station, for example a base station of a cell, transmits.

A communication system and associated devices typically operate in accordance with a given standard or specification which sets out what the various entities associated with the system are permitted to do and how that should be achieved. Communication protocols and/or parameters which shall be used for the connection are also typically defined. Non-limiting examples of standardised radio access technologies include GSM (Global System for Mobile), EDGE (Enhanced Data for GSM Evolution) Radio Access Networks (GERAN), Universal Terrestrial Radio Access Networks (UTRAN) and evolved UTRAN (E-UTRAN). An example communication system architecture is the long-term evolution (LTE) of the Universal Mobile Telecommunications System (UMTS) radio-access technology. The LTE is standardized by the third Generation Partnership Project (3GPP). The LTE employs the Evolved Universal Terrestrial Radio Access Network (E-UTRAN) access and a further development thereof which is sometimes referred to as LTE Advanced (LTE-A).

Since introduction of fourth generation (4G) services increasing interest has been paid to the next, or fifth generation (5G) standard. 5G may also be referred to as a New Radio (NR) network. Standardization of 5G or New Radio networks is an on-going study item.

Some network operators have encouraged opening up control of the radio access network (RAN), in particular of the radio resource management (RRM) functions. The xRAN consortium (http://www.xran.org/) has been formed to promote open application programming interfaces (APIs) into the RAN. These APIs are expected to be multi-vendor open.

### STATEMENT OF INVENTION

In a first aspect there is provided a method comprising: providing admission control information from a radio access node to a controller of the radio access node; and in response to the providing admission control information, receiving from the controller information comprising an instruction for the radio access node to modify admission control criteria of the radio access node; and modifying the admission control criteria in response to the instruction.

According to an example the admission control information provided to the controller comprises information of one or more admission control decisions made at the radio access node.

According to an example, the admission control information comprises one or more of: a forecast of resources that the radio access node predicts will be required to support one or more admissions; information of maximum allowed resources available to the radio access node; information of unused resources available to the radio access node.

According to an example, the admission control information comprises information of whether the one or more admissions is one or more of: user-equipment originating; user-equipment terminating; relates to a handover; information of channel quality of a UE at a time of an admission control decision.

According to an example, the admission control information comprises information of a requested bearer.

According to an example, the admission control information comprising information of one or more measurements of resources consumed following admission.

According to an example, the receiving from the controller information instructing the radio access node to modify admission control criteria of the radio access node comprises receiving a command to make the admission control stricter or less strict.

According to an example, the command comprises a binary or N-ary counter.

According to an example, the information received from the controller instructing the radio access node to modify admission control criteria of the radio access node does not specify how the radio access node is to implement the modification.

According to an example, the information received from the controller instructing the radio access node to modify admission control criteria of the radio access node causes the radio access node to modify admission control criteria preconfigured in the radio access node.

According to an example, the information received from the controller instructing the radio access node to modify admission control criteria of the radio access node causes the radio access node to modify estimation criteria used for admission control by the radio access node.

According to an example, the information received from the controller instructing the radio access node to modify admission control criteria of the radio access node comprises one or more offsets.

According to an example, the one or more offsets comprise one or more of: a first offset for adjusting forecast values of the admission control criteria; a second offset for adjusting a level of allowed resources; a third offset for adjusting a level of available resources.

According to an example, the offsets may be additive or multiplicative offsets.

According to an example, the radio access node comprises a base station.

According to an example the base station comprises a gNB.

According to an example the controller comprises an xRAN controller.

According to a second aspect there is provided a method comprising: receiving at a controller admission control information from a radio access node; processing the received admission control information at the controller; and sending to the radio access node information comprising an instruction for the radio access node to modify admission control criteria of the radio access node, based on the processed admission control information.

According to an example, the received admission control information is associated with one or more admission control decisions made at the radio access node.

According to an example, the received admission control information comprises one or more of: a forecast of resources that the radio access node predicts will be required to support the one or more admissions; information of maximum allowed resources available to the radio access node; information of unused resources available to the radio access node.

According to some examples, the received admission control information comprises information of whether the one or more admissions is one or more of: user-equipment originating; user-equipment terminating; relates to a handover; information of channel quality of a UE at a time of an admission control decision.

According to an example, the received admission control information comprises information of a requested bearer.

According to an example, the received admission control information comprises information of one or more measurements of resources consumed following admission.

According to an example, the processing the received admission control information comprises estimating one or more inaccuracies in admission control criteria of the radio access node.

According to an example, the instruction to modify admission control criteria of the radio access node comprises a command to make the admission control stricter or less strict.

According to an example, the command comprises a binary or N-ary counter.

According to an example, the instruction to modify admission control criteria of the radio access node does not specify how the radio access node is to implement the modification.

According to an example, the instruction to modify admission control criteria of the radio access node causes the radio access node to modify admission control criteria preconfigured in the radio access node.

According to an example, the instruction to modify admission control criteria of the radio access node causes the radio access node to modify estimation criteria used for admission control by the radio access node.

According to an example, the processing the received admission control information comprises calculating one or more offsets.

According to an example, the one or more offsets comprises one or more of: a first offset for adjusting forecast values of the admission control criteria; a second offset for adjusting a level of allowed resources; a third offset for adjusting a level of available resources.

According to an example, the offsets may be additive or multiplicative offsets.

According to an example, the controller comprises an xRAN controller.

According to an example, the radio access node comprises a base station.

According to an example, the radio access node comprises a gNB.

According to a third aspect there is provided a computer program comprising program code means adapted to perform the steps of the first aspect when the program is run on a data processing apparatus.

According to a fourth aspect there is provided a computer program comprising program code means adapted to perform the steps of the second aspect when the program is run on a data processing apparatus.

According to a fifth aspect there is provided an apparatus comprising at least one processor, and at least one memory including computer program code, wherein the at least one memory and the computer program code are configured, with the at least one processor, to: provide admission control information from the apparatus to a controller of the apparatus; and in response to the providing admission control information, receive from the controller information comprising an instruction for the apparatus to modify admission control criteria of the apparatus; and modify the admission control criteria in response to the instruction.

According to an example the admission control information provided to the controller comprises information of one or more admission control decisions made at the apparatus.

According to an example, the admission control information comprises one or more of: a forecast of resources that the apparatus predicts will be required to support one or more admissions; information of maximum allowed resources available to the apparatus; information of unused resources available to the apparatus.

According to an example, the admission control information comprises information of whether the one or more admissions is one or more of: user-equipment originating; user-equipment terminating; relates to a handover; information of channel quality of a UE at a time of an admission control decision.

According to an example, the admission control information comprises information of a requested bearer.

According to an example, the admission control information comprises information of one or more measurements of resources consumed following admission.

According to an example, the receiving from the controller information instructing the apparatus to modify admission control criteria of the radio access node comprises receiving a command to make the admission control stricter or less strict.

According to an example, the command comprises a binary or N-ary counter.

According to an example, the information received from the controller instructing the apparatus to modify admission control criteria of the apparatus does not specify how the apparatus is to implement the modification.

According to an example, the information received from the controller instructing the apparatus to modify admission control criteria of the apparatus causes the apparatus to modify admission control criteria preconfigured in the apparatus.

According to an example, the information received from the controller instructing the apparatus to modify admission control criteria of the apparatus causes the apparatus to modify estimation criteria used for admission control by the apparatus.

According to an example, the information received from the controller instructing the apparatus to modify admission control criteria of the apparatus comprises one or more offsets.

According to an example, the one or more offsets comprise one or more of: a first offset for adjusting forecast values of the admission control criteria; a second offset for adjusting a level of allowed resources; a third offset for adjusting a level of available resources.

According to an example, the offsets may be additive or multiplicative offsets.

According to an example, the apparatus comprises a radio access node.

According to an example, the apparatus comprises a base station.

According to an example the base station comprises a gNB.

According to an example the controller comprises an xRAN controller.

According to a sixth aspect there is provided an apparatus comprising at least one processor, and at least one memory including computer program code, wherein the at least one memory and the computer program code are configured, with the at least one processor, to: receive at the apparatus admission control information from a radio access node; process the received admission control information at the apparatus; and send to the radio access node information comprising an instruction for the radio access node to modify admission control criteria of the radio access node, based on the processed admission control information.

According to an example, the received admission control information is associated with one or more admission control decisions made at the radio access node.

According to an example, the received admission control information comprises one or more of: a forecast of resources that the radio access node predicts will be required to support the one or more admissions; information of maximum allowed resources available to the radio access node; information of unused resources available to the radio access node.

According to some examples, the received admission control information comprises information of whether the one or more admissions is one or more of: user-equipment originating; user-equipment terminating; relates to a handover; information of channel quality of a UE at a time of an admission control decision.

According to an example, the received admission control information comprises information of a requested bearer.

According to an example, the received admission control information comprises information of one or more measurements of resources consumed following admission.

According to an example, the processing the received admission control information comprises estimating one or more inaccuracies in admission control criteria of the radio access node.

According to an example, the instruction to modify admission control criteria of the radio access node comprises a command to make the admission control stricter or less strict.

According to an example, the command comprises a binary or N-ary counter.

According to an example, the instruction to modify admission control criteria of the radio access node does not specify how the radio access node is to implement the modification.

According to an example, the instruction to modify admission control criteria of the radio access node causes the radio access node to modify admission control criteria preconfigured in the radio access node.

According to an example, the instruction to modify admission control criteria of the radio access node causes the radio access node to modify estimation criteria used for admission control by the radio access node.

According to an example, the processing the received admission control information comprises calculating one or more offsets.

According to an example, the one or more offsets comprises one or more of: a first offset for adjusting forecast values of the admission control criteria; a second offset for adjusting a level of allowed resources; a third offset for adjusting a level of available resources.

According to an example, the offsets may be additive or multiplicative offsets.

According to an example, the apparatus comprises a controller.

According to an example the controller comprises an xRAN controller.

According to an example, the radio access node comprises a base station.

According to an example, the radio access node comprises a gNB.

According to a seventh aspect there is provided.

According to a seventh aspect there is provided an apparatus comprising: means for providing admission control information from the apparatus to a controller of the apparatus; and in response to the providing admission control information, receiving from the controller information comprising an instruction for the apparatus to modify admission control criteria of the apparatus; and modifying the admission control criteria in response to the instruction.

According to an eighth aspect there is provided an apparatus comprising means for receiving at a controller admission control information from a radio access node; means for processing the received admission control information at the controller; and means for sending to the radio access node information comprising an instruction for the radio access node to modify admission control criteria of the radio access node, based on the processed admission control information.

### BRIEF DESCRIPTION OF FIGURES

The invention will now be described in further detail, by way of example only, with reference to the following examples and accompanying drawings, in which:

FIG. 1 shows a schematic example of a wireless communication system where the invention may be implemented;

FIG. 2 shows an example of a communication device;

FIG. 3 shows an example of a control apparatus;

FIG. 4 schematically shows a system according to an example;

FIG. 5 schematically shows parts of a system according to an example;

FIG. 6 schematically shows parts of a system according to an example;

FIG. 7 schematically shows a flow chart of a method according to an example;

FIG. 8 schematically shows a controller according to an example;

FIG. 9 schematically shows parts of a system according to an example;

FIG. 10 is a message sequence chart according to an example;

FIG. 11 is a message sequence chart according to an example;

FIG. 12 is a flow chart of a method according to an example;

FIG. 13 is a flow chart of a method according to an example.

### DETAILED DESCRIPTION

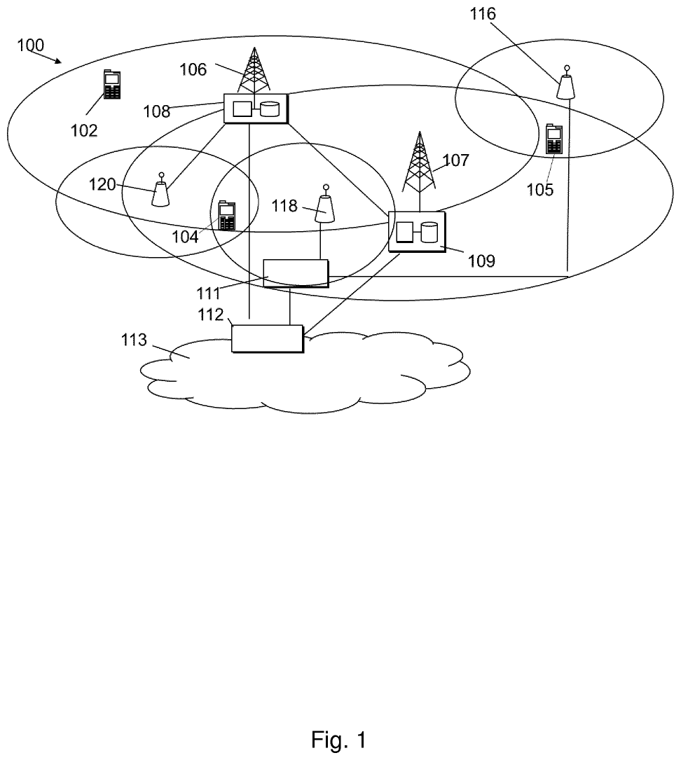

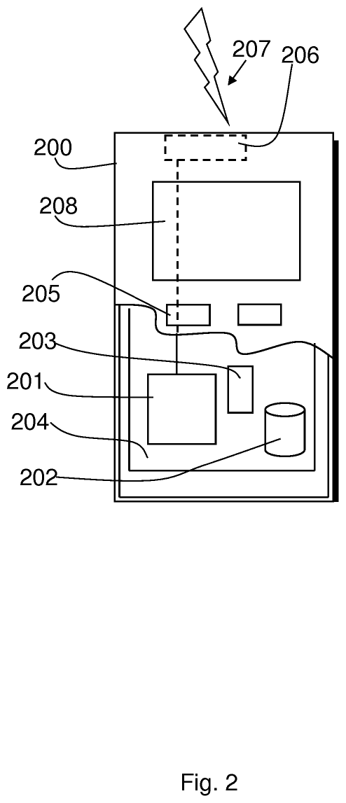

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, a wireless communication devices, for example, user equipment (UE) or MTC devices 102, 104, 105 are provided wireless access via at least one base station or similar wireless transmitting and/or receiving wireless infrastructure node or point. Such a node can be, for example, a base station or an eNodeB (eNB), or in a 5G system a Next Generation NodeB (gNB), or other wireless infrastructure node. These nodes will be generally referred to as base stations. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a radio access network controller or a standalone controller. In FIG. 1 control apparatus 108 and 109 are shown to control the respective macro level base stations 106 and 107. In some systems, the control apparatus may additionally or alternatively be provided in a radio access network controller. Other examples of radio access system comprise those provided by base stations of systems that are based on technologies such as 5G or new radio, wireless local area network (WLAN) and/or WiMax (Worldwide Interoperability for Microwave Access). A base station can provide coverage for an entire cell or similar radio service area.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided.

A possible wireless communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. In the present teachings the terms UE or “user” are used to refer to any type of wireless communication device.

The wireless device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the wireless device.

A wireless device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the wireless device by means of a suitable user interface such as key pad 205, voice commands, touch sensitive screen or pad, combinations thereof or the like. A display 208, a speaker and a microphone can be also provided. Furthermore, a wireless communication device may comprise appropriate connectors (either wired or wireless) to other devices and/or for connecting external accessories, for example hands-free equipment, thereto. The communication devices 102, 104, 105 may access the communication system based on various access techniques.

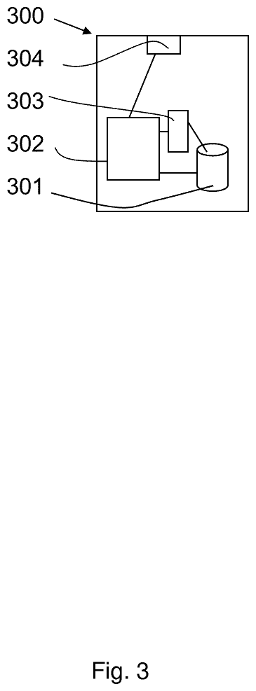

FIG. 3 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 or processor 201 can be configured to execute an appropriate software code to provide the control functions.

The present inventors have identified that there is a need for designing a controller that can interface to a wireless radio access network (RAN) by means of suitably defined interfaces such as application programming interfaces (APIs). The interface between the controller and the interface between the controller and the access point (for example the gNB), should be targeted for optimization of the RAN, and do so by use of analytics/machine learning. The present inventors have identified some features and/or functionality to be incorporated into such Controllers and APIs.

The API should support: (i) a data exposure API from the RAN to the controller. The data exposure API would observe/analyze data allowing the controller to determine optimization actions. The API should also support (ii) a control API. The control API will enable the controller to tell the RAN to take certain actions.

Functionality to be supported on these APIs (i.e. the data to be exposed, and the control actions to be enabled) support target use-cases. Such target uses may include optimization of radio resource management (RRM) algorithms in RAN, such as the optimization of admission control decisions made by the RAN.

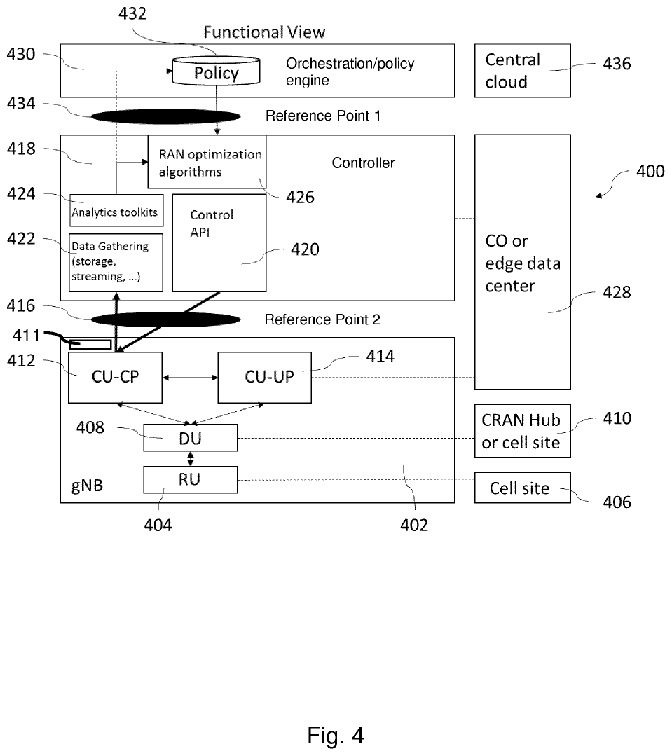

FIG. 4 schematically shows a proposed system architecture. The system is generally shown at 400. The system 400 comprises a RAN Node such as a gNB 402 in this example, although in other examples the type of RAN node may differ (e.g. eNB etc.). The gNB 402 comprises the following interfaces or functional units: RU (radio unit) 404 which is connected to a cell site 406; DU (distributed unit) 408 which is connected to GRAN (cloud RAN) hub or cell site 410; CU-CP (central unit—control plane) 412; CU-UP (central unit—user plane) 414. The units are in communication with each other as schematically shown by the double headed arrows. The gNB 402 also comprises a RAN API handler shown schematically at 411. The RAN API handler 411 may also be in communication with other units of the gNB 402, and in some examples may also be in communication with controller 418.

The gNB 402 is in communication with, and may be controlled by, controller 418. Controller 418 may be comprised in the core network (CN), in some examples. In other examples the controller 418 may be instantiated closer to the RAN nodes e.g. in an edge cloud. Communication between gNB 402 and controller 418 may be via Reference Point 2, labeled as 416. The Controller 418 comprises the following functional units shown schematically: control API 420, which may send control information to gNB 402 (e.g. to CU-CP 412); data gathering unit 422, which may gather data from gNB 402 (e.g. may receive information from CU-CP 412); analytics toolkits 424; and services performing RAN optimization algorithms 426. In this example the controller 418 may be hosted at a Central Office (CO) or edge data centre 428.

A policy node is schematically shown at 430. This may be an Orchestration/Policy Engine. The policy node 430 comprises a policy database or processing engine 432. In this example the policy node 430 is in communication with controller 418 via Reference Point 1, labeled 434. In this example policy node 430 is hosted at a central cloud, shown schematically at central cloud 436.

In some examples, the RAN Control Plane (CP or CU-CP) 412 performs admission control for every call or session or bearer setup request, to decide if the call (or session or bearer) with its requested parameters can be supported. Herein, for conciseness, the term “call” may also be interchanged with the word “session” or “bearer”. In some examples the internal admission control algorithm in the CP typically has: (i) a set of actions executed at each call request, (ii) a set of internal metrics that are periodically updated and used for forecasting the required resources for the call request, (iii) a set of total allowed resources for allocating to calls, etc. (iv) a set of configuration parameters—e.g. for max number of RRC connected users, max number of incoming handovers, max allowed resources for GBR, etc.

There may be some challenges associated with attaining optimal performance of the admission control algorithms in the RAN.

For example the configuration parameters are typically set statically as template values for all cells, regardless of the actual characteristics of the cell such as load or signal propagation or interference. However, any individual cell may be very different from other cells, e.g. in terms of the number of users, the number of anticipated handovers, the mix of traffic (e.g. GBR (guaranteed bit rate) vs nonGBR), the distribution of users' SINR (signal to noise ratio) within the cell, etc. These values may vary a lot from cell to cell, and may also vary over time within the same cell.

Furthermore, the needed resources forecast by the eNB/gNB may turn out to be inaccurate. For example a call or session may actually need either more or less resources at various times (e.g. as the channel conditions of the UE change).

Furthermore, the allowed resources that the eNB/gNB assumes in the workings of its admission control criteria may be inaccurate (e.g. too high or too low). This may be the case for example if RAN uses a maximum number of anticipated handover users in order to estimate the allowed resources. This may be based on just a static configuration parameter, while in reality the number of incoming handovers may vary significantly over time and from cell to cell.

Furthermore, the RAN is typically constrained in terms of how much data it can store or analyze. Typically the eNB can only maintain short-term counters etc, and is unable to perform long-time-scale statistical analysis or machine learning, which could help it to reduce such inaccuracies.

One possible way to improve the situation, identified by the present inventors, is to enable an API from the RAN towards a controller. This API enables RAN to expose relevant data to the controller, using which the controller can perform statistical analysis and/or machine learning to learn the relevant characteristics of each cell and determine optimal adjustments that need to be made to the operation of the admission control algorithm in the RAN. This may enable the controller to tell the RAN to make optimal adjustments so as to overcome the above challenges. This can be seen for example in the example of FIG. 4, where controller 418 (comprising control API 420), located in or in communication with edge data centre 428, communicates with gNB 402 in RAN. As mentioned, in this example the controller 418 is located in CO or edge data centre 428.

It should be noted that the RAN nodes may be LTE eNB and/or 5G gNB, or RAN nodes based on other wireless technologies. This applies for both bare-metal eNB/gNB as well as cloud-based/decomposed architectures for eNB/gNB.

Therefore as described in more detail below, there is proposed an API or set of APIs, and a method for a controller to be able to optimize the admission control algorithm(s) in the RAN.

It should be noted that, in at least some examples, the controller is not itself intended to perform the admission control decisions for all calls or bearers or sessions that are attempted to be set up in the RAN node(s). Those decisions may still be made by the RAN node(s). However, the criteria used by the RAN node(s) for making such decisions can be optimally adjusted by the controller, using the API as described herein.

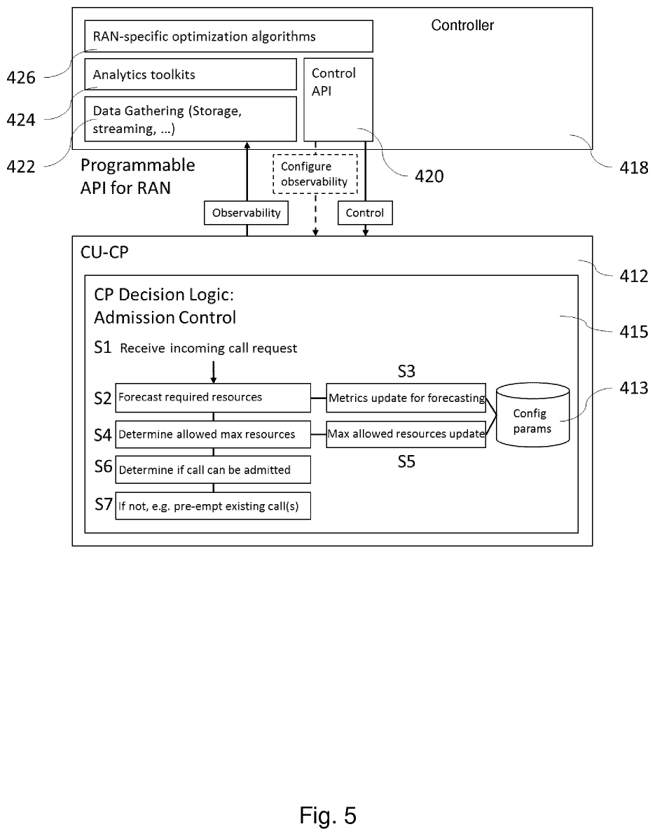

FIG. 5 shows in more detail certain aspects of FIG. 4. As shown, the control API 420 in controller 418 can control CU-CP 412 in RAN 402. The admission control algorithm for the RAN (e.g. gNB 402) is shown generally at 415. Furthermore, in examples, the controller 418 can observe data regarding various events and metrics related to the cell or the users/sessions therein, and the decisions made by the CU-CP 412 (or more generally, the RAN node 402) and gathered data thereon. In examples the controller 418 can also configure the observability of such data. That is the controller 418 may, for example, configure the RAN node to send appropriate information and/or metrics to the controller 418.

FIG. 5 also shows a flow of an example admission control logic, and criteria employed by the RAN node.

At S1, an incoming call request is received by the RAN node. The incoming call request may contain various attributes or quality-of-service (QoS) parameters of the call or bearer(s) that are being requested, such as a desired bit-rate, a desired latency, a desired packet-discard rate, etc.

At S2, the resources likely to be required for ensuring the appropriate QoS attributes for the call are forecast.

This may use various metrics, which may be periodically (or at certain events) updated at S3.

At S4, a level of maximum resources allowed for calls, and/or a level of currently available resources, are determined. This determination may be made by various internal metrics that are updated periodically or at certain events, at S5.

Then, at S6 a determination is made as to whether a call can be admitted.

If the call cannot be admitted based on resource availability, then the RAN node may take further decisions, such as pre-empting (i.e. terminating and releasing resources of) other existing call(s), such as calls which have a lower retention priority than the call for which the admission request is being processed, as shown at S7.

In some examples, the steps do not necessarily have to occur in this order. For example, S3 does not necessarily need to occur directly after S2, and S5 does not necessarily need to occur directly after S4 (e.g. these could be updated at a later time). It should be noted that these steps are examples, and other appropriate logic for admission control may be employed by the RAN node.

The determination of the forecasted resources and maximum allowed resources (and/or available resources) may be based on certain configuration parameters that are typically stored in a memory or database as shown schematically at 413. The memory 413 may be configured generally to store configuration parameters (e.g. including further parameters other than forecasting and allowed resources metrics).

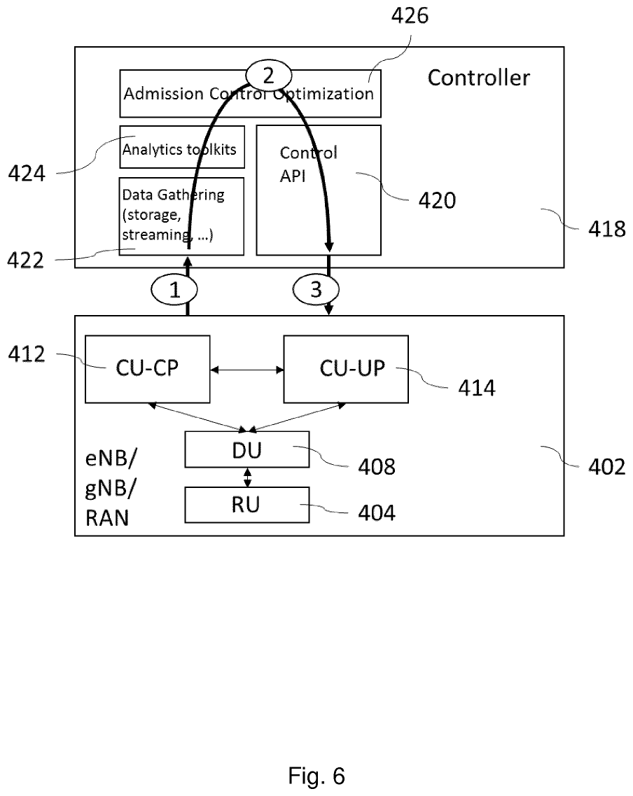

Some examples will now be described with respect to FIG. 6, which again shows in more detail some aspects of FIG. 4.

There is first described a method of optimizing the criteria used by the admission control algorithm in eNB/gNB/RAN 402. The arrow marked “1”, pointing from gNB 402 to controller 418, represents provision by the gNB 402 to controller 418 of a set of data and/or attributes related to admission control decisions made by gNB 402. In other words, the admission control information provided to the controller may comprise information of one or more admission control decisions made at the radio access node.

For each call/bearer setup request or handover request where an admission control decision is made in the RAN, the RAN (e.g. gNB 402) may provide to controller 418 information (e.g. certain quantities) used by the RAN in making its admission control decision. The RAN may also provide other related parameters obtained at the time of the call request, as well as certain parameters that may be obtained subsequent to the admission control decision. This information may include:
information about the call setup request
initial channel quality attributes or RF fingerprint information about the UE at the time of the call setup request
measures of the number or quantity of resources actually consumed by the call subsequent to the admission control decision, etc.

In more detail, data/attributes related to admission control decisions made by the eNB/gNB/RAN 402, provided by the eNB/gNB/RAN 402 to the controller 418, may comprise one or more of the following:

(i) For each call/bearer setup request or handover request where an admission control decision is made in the RAN, the RAN should provide to controller certain quantities used by the RAN in making its admission control decision at the time of the call request, which may include one or more of:
The forecast number of resources (e.g. physical resource blocks (PRBs)) that the RAN predicts will be needed to support the call
The maximum allowed resources determined to be allowed by the RAN at the time of making the decision
The available resources or headroom or spare/unused resources estimated to be available by RAN
   (ii) Information about the call setup request, which may include one or more of:
Whether the request is for a mobile/UE-originated or mobile/UE-terminated call, or whether it is an incoming handover, etc.
Attributes of the requested bearer—for example min/max/guaranteed bit-rate, max delay, etc.
   (iii) Initial channel quality attributes or RF fingerprint information about the UE at the time of the call setup request, which may include one or more of:
the CQI (channel quality indicator), most recent RSRP/RSRQ (reference signal received power/reference signal received quality), path loss measured by eNB, power headroom from PHR (power headroom) report, etc.
   (iv) Measures of the number of resources actually consumed by the call, for example:
A minimum number of resources, and/or a maximum number of resources
A histogram (e.g. bins and counts) of number of resources consumed by a call or session
This information may be tracked periodically during the call, or accumulated over the entire duration of the call, etc.

In other words, the RAN 402 may provide to the controller 418 admission control information comprising one or more of: a forecast of resources that the radio access node predicts will be required to support one or more admissions; information of maximum allowed resources available to the radio access node; information of unused resources available to the radio access node. According to some examples, the admission control information provided by the RAN 402 to the controller 418 may comprise information of whether the one or more admissions is user-equipment originating or user-equipment terminating, or relates to a handover, or relates to the channel quality of a UE at the time of the admission control decision. According to some examples the admission control information comprises information for a requested bearer.

In FIG. 6, the arrow marked “2” (i.e. the curved arrow passing through controller 418) represents decision making (by the controller 418). For example this may be decision making on modifications to the admission control criteria or decision logic in the eNB/gNB/RAN 402.

The arrow marked “3” (i.e. passing from controller 418 to gNB 402), schematically represents sending the modifications to the admission control decision logic of the gNB 402. This may be in the form of, for example:
Option 1: A command that tells the RAN to make its admission control more relaxed/looser (i.e. in the direction of admitting more calls), or stricter/tighter (in the direction of admitting fewer calls).
Option 2: A command to modify certain values that were originally derived from configuration parameters. Therefore in some examples information received from the controller 418 instructing the radio access node 402 to modify admission control criteria of the radio access node may cause the radio access node 402 to modify admission control criteria preconfigured in the radio access node 402.
Option 3: A command to modify certain values that would be estimated by the eNB within its own admission control algorithm. Or in other words the information received from the controller 418 instructing the radio access node 402 to modify admission control criteria of the radio access node 402 may cause the radio access node 402 to modify estimation criteria used for admission control by the radio access node

These options (i.e. options 1 to 3) are explained in more detail below:
Option 1: A command that tells the RAN to make its admission control more relaxed/looser (i.e. in the direction of admitting more calls), or stricter/tighter (i.e. in the direction of admitting fewer calls). This command may be a binary indicator (e.g. 0 for “tighter”, 1 for “looser”), or N-ary (e.g. values 1 . . . N, with 1 meaning completely stop admitting calls, and N meaning admit all calls without constraint, etc). In this option, in some examples exactly how the RAN adapts its internal algorithm to effect this change may not be specified in the command. That is the command may instruct the RAN node (e.g. gNB 402) to adapt its internal algorithm, and the RAN node may be free to make its own internal determination of exactly which aspects of its admission control decision criteria need to be adapted to comply with the instruction from the controller. This may for example be the case when the API is defined as an intent-based API, and wherein the controller's instruction expresses the intent (e.g. that the admission control should be made more relaxed or more strict), while the RAN node makes its own determination of which aspects to adjust in order to meet the intent of the instruction. In other words, in some examples the information received from the controller instructing the radio access node to modify admission control criteria of the radio access node does not specify how the radio access node is to implement the modification.
Option 2: A command to modify certain values that were originally derived from configuration parameters. For example, this may instruct the RAN node (e.g. gNB 402) to modify, for example, the anticipated maximum number of connected users, or the anticipated maximum number of GBR calls, or the anticipated maximum number of incoming handovers, etc., which ordinarily may have been statically configured parameters. In other words, the information received from the controller instructing the radio access node to modify admission control criteria of the radio access node may cause the radio access node to modify admission control criteria preconfigured in the radio access node.
Option 3: A command to modify certain values that would be estimated by the eNB within its admission control algorithm. For example this may instruct the RAN node to modify e.g. the way the forecast of resources needed for the call is calculated by the RAN node. For example, the controller's command may provide the RAN node with an offset such that, when the forecast is computed internally by eNB/gNB at the time of making an admission control decision, the RAN node modifies the forecast of resources by the provided offset. The offset(s) may be additive or multiplicative offsets. The command may modify, for example, the headroom (available resources) or maximum allowed resources as computed internally by the eNB/gNB. This may be accomplished by providing the RAN an offset (such as an additive or multiplicative offset) to apply to its determined value of the available or max allowed resources. In other words, the information received from the controller instructing the radio access node to modify admission control criteria of the radio access node may cause the radio access node to modify estimation criteria used for admission control by the radio access node.

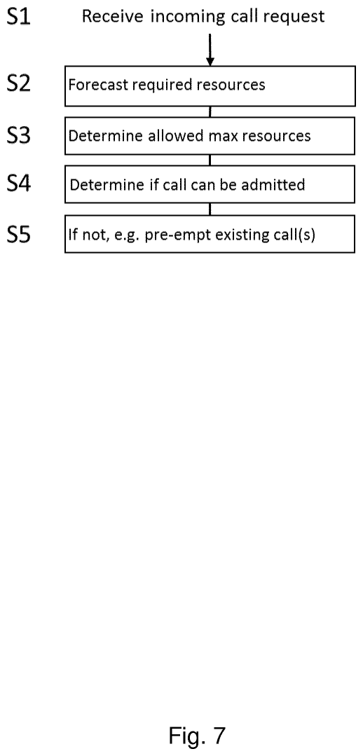

FIG. 7 summarizes decision making by RAN for call admission.

At S1, an incoming call request is received.

At S2, required resources are forecast.

At S3, a determination is made of allowed maximum resources.

At S4, a determination is made of whether the call can be admitted.

At S5, if the call cannot be admitted, existing calls are pre-empted.

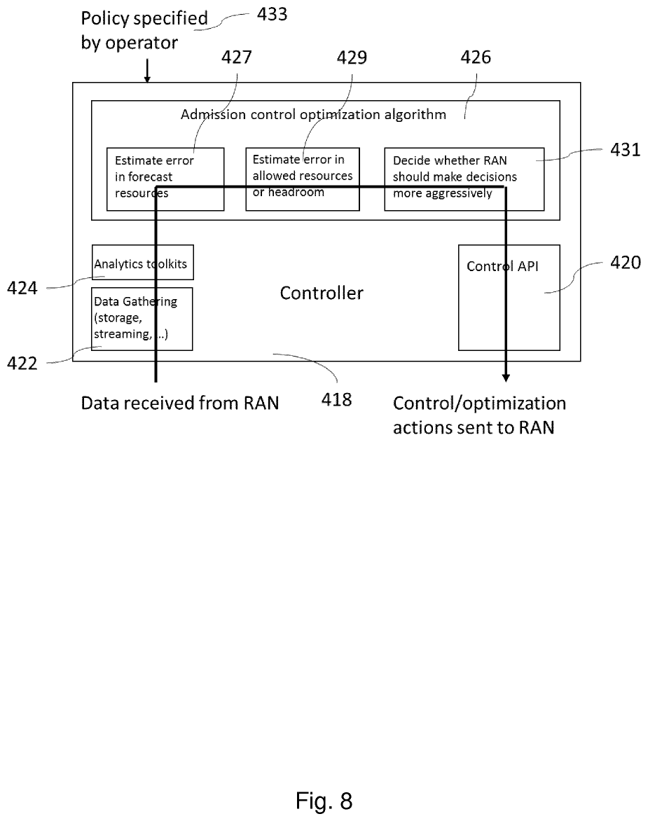

FIG. 8 shows in more detail an example algorithm 426 used by controller 418 for optimally adapting the admission control decision algorithm of the RAN node 402. As shown schematically, the admission control optimization algorithm 426 can (i) estimate inaccuracies in the forecast of required resources made by the RAN node (427); (ii) estimate inaccuracies in the level of allowed resources or headroom/available resources estimated by the RAN node (429); (iii) decide how the RAN node should make its admission control decisions (e.g. make the decisions tighter or looser) (431). In other words, in examples the algorithm 426 may be able to determine inaccuracies in information or forecasts of the RAN. This is explained in more detail below.

Based on data received from the RAN (e.g. gNB 402), the controller 418 may use analytics to generate an estimate of an error or inaccuracy between the resource forecast by the RAN at the time of the actual admission control decision. The inaccuracy may be determined relative to a maximum (or other metric, e.g. 95% ile) of resources actually consumed by the call during its lifetime.

The controller 418 may also use analytics to generate an estimate of an error or inaccuracy between maximum allowed resources used by the RAN (or spare/available resources estimated by the RAN) and the actual spare/available headroom or maximum allowed resources.

These estimates may be made by, for example, regression or model-based fitting or other estimator/predictor (e.g. neural network), or any suitable parametric or non-parametric method.

The controller 418 may then determine how the RAN (e.g. gNB 402) should adapt its admission control decisions, e.g. by making the decisions more conservatively or more aggressively. For example the controller may determine whether the RAN should be admitting fewer calls or a larger number of calls.

The controller 418 may then communicate control actions to the RAN accordingly. The exact control actions may depend on which of the different options mentioned above are chosen (e.g. which of options 1 to 3).

In some examples an operator can specify a policy input which can be provided to the controller 418. The policy input may be, for example, one or more of: a target call blocking rate; a target call pre-emption rate; a maximum number of calls to be admitted; a target ratio of guaranteed-bit-rate to non-guaranteed-bit-rate traffic; instructions regarding desired or targeted behavior at different times of the day, etc.

In FIG. 8 policy input is schematically shown at 433, and may be understood to correspond to the policy input provided to the controller over Reference Point 1 in FIG. 4. In some examples the controller 418 can adapt or modulate its optimization decisions (e.g. decisions on whether the admission control should be tighter or looser) based on this input. That is in some examples the controller may instruct the RAN to adapt its admission control decision criteria based on such policy input.

As previously discussed, the RAN (e.g. gNB 402) also provides information to the controller 418 to enable the controller 418 to perform admission control optimization. The data provided by the RAN to the controller may consist of various elements.

The data provided by the RAN to the controller may include information related to each admission control request/decision made by the RAN. Quantities used by the RAN in its internal decision algorithm, which may be provided to the controller 418 may include information of one or more of: a forecast number of resources (e.g. PRBs) that the RAN predicts will be needed to support the call; the maximum allowed resources assumed by the RAN at the time of making the decision; the headroom or spare/unused resources estimated to be available by RAN. Information related to each admission control request/decision made by the RAN may also include information about the call setup request. The call setup request information may include information of whether the request is for a mobile-originated or mobile-terminated call, or whether it is an incoming handover, etc; attributes of the requested bearer—min/max/guaranteed bit-rate, max delay, etc.

The data provided by the RAN to the controller 418 may also include other information about the UE at the time the admission control decision was made. For example the UE information may include one or more of: initial channel quality attributes or RF fingerprint information about the UE at the time of the call setup request; the CQI (channel quality indicator), most recent RSRP/RSRQ, path loss measured by eNB, power headroom from PHR report, etc. These may or may not have been directly used by the eNB in making its decision.

The data provided by the RAN to the controller 418 may include information about what actually happened to the UE/call after the admission control decision. For example this information may include, a measure of the number or quantity of resources actually consumed by the call, which may include information of one or more of: a minimum number or quantity of resources; a maximum number or quantity of resources; a histogram (bins and counts) of number of resources consumed by the call. This information may be tracked periodically during the call, or accumulated over the entire duration of the call, etc.

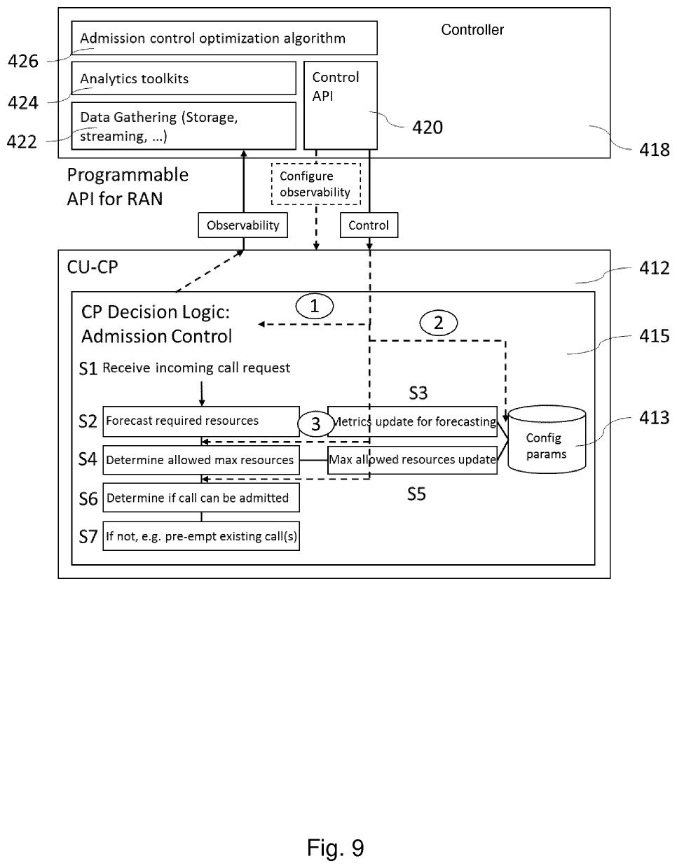

FIG. 9 is a development of FIG. 5. FIG. 9 shows how the control information may be distributed to the CU-CP 412 of gNB 402, according to an example. The dashed arrow “1” shows control information going to CP decision logic:admission control. Dashed arrow “2” shows the control information going to configuration parameters store 413. Dashed arrow “3” shows how the control information can be sent to CU-CP for direct use in decision making e.g. for use in adapting the calculations in steps S4 and S6 of FIG. 9 (and FIG. 5).

As discussed above, the control commands may take various forms, which have been described above as options 1 to 3. For consistency this terminology will be continued, and these options 1 to 3 are again explained in more detail below.

In “Option 1” the command may be a binary indication e.g. “increase” or “decrease”, or may take one of N values e.g. between 0 and 10. For example 0 may indicate stop admitting calls altogether, and 10 may indicate that calls can be freely admitted. This can be considered as an “intent-based indication”, indicating the intent of the controller. Internally the way it is incorporated by RAN may be left to the RAN implementation.

An example response by RAN may include the RAN performing its internal calculations as it otherwise would have, but also applying an internal offset to some of the values. This may include, for example, either increasing or decreasing its forecast of needed resources, based on whether the controller's instruction is to make the admission control tighter or looser.

The controller may iteratively update its command(s), so as to accurately reach a desired state regardless of the RAN's actual implementation.

“Option 1” may be most suitable for multi-vendor common specification.

In “Option 2”, in response to receiving control commands from the controller 418, the RAN may not necessarily change the configuration parameters directly (since the master copy of those is typically at the Element Management System (EMS) but may modify its internal copy of a dynamic variable corresponding to these configuration parameters.

“Option 3” may give more granular or finer regulation of the RAN's admission control algorithm 415 to the controller 418. Option 3 may require more specific assumptions by the controller. This option may enable operators to include proprietary extensions to the admission control algorithm 415, rather than for example using a multi-vendor common specification

In some examples, using option 3 the additive and multiplicative offsets may be defined as follows:
Forecast-usage-modification-factor (or forecast information): The internal RAN/CP Admission Control algorithm will scale the internal forecast of the PRBs needed by a new call seeking admission by this factor. This may be considered a first offset.
Allowed-resources-modification-factor (or allowed resources information): The internal RAN/CP Admission Control algorithm will scale the configured desired maximum PRBs for GBR traffic by this (additive or multiplicative) factor. This may be considered a second offset.
A third offset may instruct adjustment of a level of available resources. The controller 418 may determine values of these factors to communicate to the RAN as described below in (1) and (2).

### (1) Estimate the Forecast-Usage-Modification-Factor

This may include comparing the forecast value used internally (based on the scheduler measurements) with the actual value of the PRBs used during a call to determine an adjustment factor which may be done as follows:
Regression to estimate “A” based on a model such as: <actual value>=A*<original forecast value>

That is the first offset may comprise an adjustment factor. The first offset may comprise a statistical regression. The regression can be any suitable statistical regression, for example a least-squares-error, or to keep the probability of being “too low” below a given desired threshold (robust estimation), etc. The value of A is communicated to the RAN as the updated value of the forecast-usage-modification-factor. The value A can be updated by the admission control optimization (ACO) algorithm at the controller periodically or after every N calls. In some examples the value A may change throughout the day. This may allow the ACO to track variations in the per-call usage to different times of the day. For example the distribution of users in any given cell can change over time. At certain times the users may be much closer to the cell tower, while at other times they may be much further away on average, or may be indoors, etc. This may change the distribution of the number of PRBs that a GBR call requires for a given bit-rate.

### (2) Estimate the Allowed-Resources-Modification-Factor

This may include generating a prediction of the estimated GBR traffic (L calls/second of new calls as well as handover calls in a cell), as well as a duration T of the calls. That is the second offset may comprise a prediction of cell traffic. This may be done either by analytics on the RAN data/metrics. Alternatively this may be done by correlating with other sources such as probes in the network, or data from key OTT applications. This information can be converted to an estimated number of ongoing calls per second, which may be either average (L*T), or considering Xth percentile (for a desired value of the target percentile X).

The total resources needed to accommodate all the desired users may then be estimated, for example based on a combination of the estimated number of ongoing calls with the per-call PRB usage. From this, the allowed-resources-modification-factor (ARMF) may be estimated as follows:

ARMF=(estimated total resources to accommodate the Xth-percentile of the ongoing calls)/(baseline config parameter value maxGbrTrafficLimit)

As shown in FIG. 8 at 433, operators may be able to specify policy to the controller 418. For example, the operator may have the ability to specify policies to the controller 418 for admission control optimization, which in turn may affect its optimization actions. Examples of policy specification include:
At defined times of the day, instruct tighter admission control
Provide a target call-blocking rate of X % (e.g. 2%)
Provide a target call-blocking rate as a function of the load. For example if load in the cell is below a threshold, then use 2% call-blocking rate, but when load is above a threshold, use a target of 3%. In some examples this may also include raising an alarm if target is not met for at least X minutes.

The controller 418 can use the policy input. For example:
For a given target call blocking rate, the controller may determine a mismatch between the target rate and the actual rate. It may combine this mismatch with its other logic as described above in determining the control action.
If an actual call-blocking rate is above target, then the controller 418 may tell the RAN to make its admission control looser (i.e. admit more users), and depending on the option for communicating the control action, it may decide to tell the RAN to modify one or more parameters or provide one or more additive or multiplicative offsets as described above.

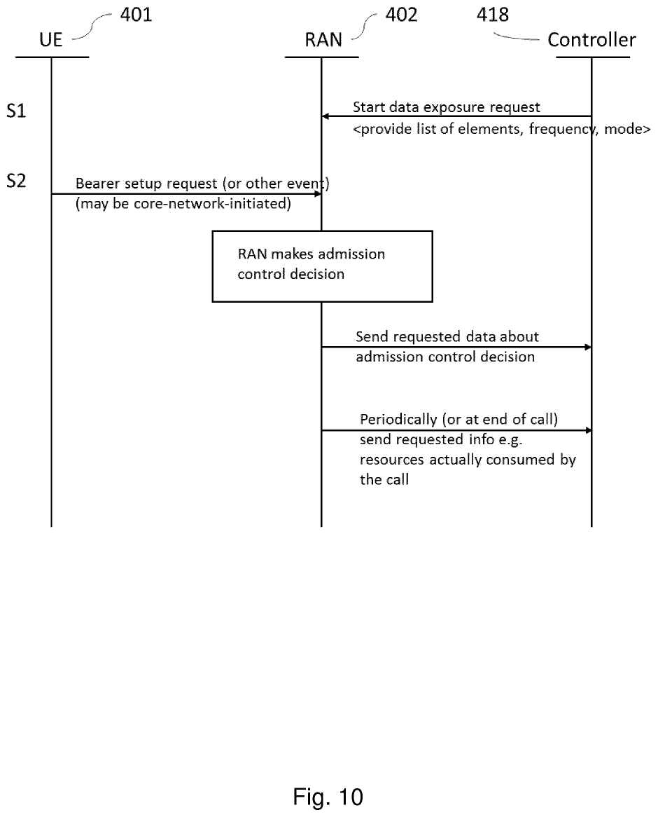

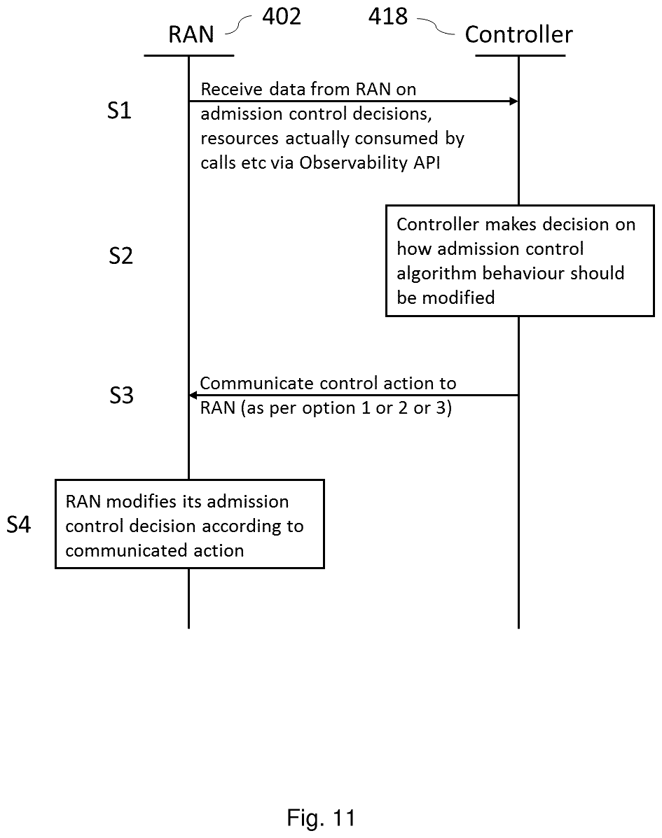

FIGS. 10 and 11 are flow charts of methods according to some examples.

FIG. 10 shows messaging between a UE 401, RAN node 402 (e.g. gNB), and controller 418.

At S1, the controller API instructs RAN 402 to start data exposure (e.g. provide information of) events and metrics related to admission control. This may include specifying frequency and/or mode of exposure. For example this may be “real-time” (e.g. send as soon as available) or streaming (e.g. queue up for sending in a batch). The request at S1 may also specify periodicity of batch reporting.

At S2, RAN 402 receives from UE 401 a request that triggers an admission control decision at the RAN 402. For example, the request may comprise a bearer set-up request. The bearer set-up request may be UE initiated (as shown in FIG. 10), or core-network initiated. Alternatively the request may be a handover request.

At S3 the RAN 402 makes an admission control decision.

Then, at S4, the RAN sends information to the controller (as requested at S1).

As shown at S5, periodically (or at the end of the call or session) the RAN 402 can provide further information about the state of the call and the system e.g. number of resources consumed by the call or session. This may comprise a histogram of resource consumption over time.

FIG. 11 schematically shows a process of RAN admission control decision modification between a RAN node 402 and controller 418.

At S1, RAN 402 sends data to controller 418 regarding one or more of admission control decisions and resources actually consumed by calls. This may be sent via the observability API of the RAN 402.

At S2, the controller 418 makes one or more decisions on how admission control algorithm behavior of the RAN 402 should be modified.

At S3, the controller communicates control actions to RAN 402 (as per option 1 or option 2 or option 3 as described above).

Then, at S4 the RAN 402 modifies its admission control algorithms according to the control message received from the controller 418 at S3.

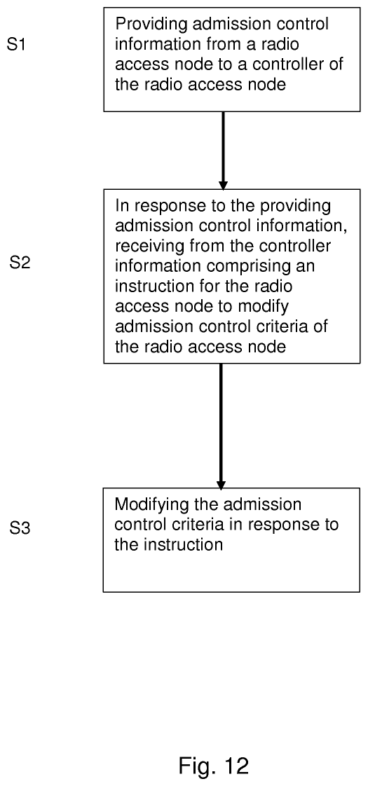

FIG. 12 is a flow chart schematically showing a method as viewed from a perspective of a radio access node (RAN).

At S1, the method comprises the radio access node providing admission control information to a controller of the radio access node.

At S2, in response to the providing admission control information, the method comprises the radio access node receiving from the controller information comprising an instruction for the radio access node to modify admission control criteria of the radio access node. For example this may be admission control criteria stored in a memory of the radio access node.

At S3, the method comprises the radio access node modifying the admission control criteria in response to the instruction.

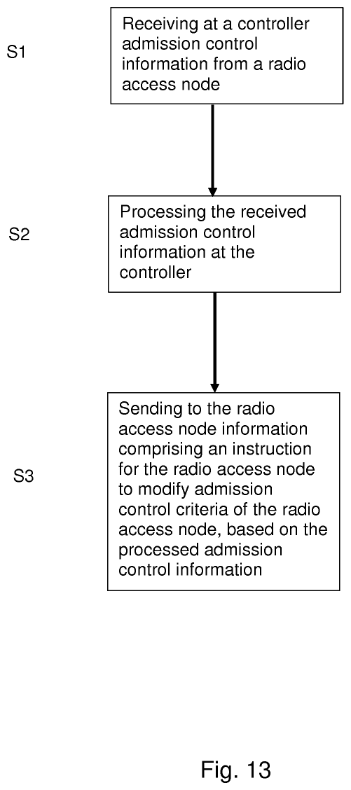

FIG. 13 is a flow chart schematically showing a method as viewed from a perspective of a controller (for example a radio access network controller).

At S1, the method comprises the controller receiving admission control information from a radio access node.

At S2, the method comprises the controller processing the received admission control information.

At S3, the method comprises the controller sending to the radio access node information comprising an instruction for the radio access node to modify admission control criteria of the radio access node, based on the processed admission control information.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
providing admission control information from a radio access node to a controller of the radio access node; and
in response to the providing admission control information, receiving from the controller information comprising an instruction for the radio access node to modify admission control criteria of the radio access node; and
modifying the admission control criteria in response to the instruction.

2. A method according to claim 1, the admission control information provided to the controller comprising information of one or more admission control decisions made at the radio access node.

3. A method according to claim 1, the admission control information comprising one or more of: a forecast of resources that the radio access node predicts will be required to support one or more admissions; information of maximum allowed resources available to the radio access node; information of unused resources available to the radio access node.

4. A method according to claim 1, the admission control information comprising information of one or more measurements of resources consumed following admission.

5. A method according to claim 1, the receiving from the controller information instructing the radio access node to modify admission control criteria of the radio access node comprising receiving a command to make the admission control stricter or less strict.

6. A method according to claim 5, the command comprising a binary or N-ary counter.

7. A method according to claim 1, wherein the information received from the controller instructing the radio access node to modify admission control criteria of the radio access node does not specify how the radio access node is to implement the modification.

8. A method according to claim 1, the information received from the controller instructing the radio access node to modify admission control criteria of the radio access node causing the radio access node to modify admission control criteria preconfigured in the radio access node.

9. A method according to claim 1, the information received from the controller instructing the radio access node to modify admission control criteria of the radio access node causing the radio access node to modify estimation criteria used for admission control by the radio access node.

10. A method according to claim 9, the information received from the controller instructing the radio access node to modify admission control criteria of the radio access node comprising one or more offsets.

11. A method according to claim 10, the one or more offsets comprising one or more of: a first offset for adjusting forecast values of the admission control criteria; a second offset for adjusting a level of allowed resources; a third offset for adjusting a level of available resources.

12. A method comprising:
receiving at a controller admission control information from a radio access node;
processing the received admission control information at the controller; and
sending to the radio access node information comprising an instruction for the radio access node to modify admission control criteria of the radio access node, based on the processed admission control information.

13. A method according to claim 12, the received admission control information associated with one or more admission control decisions made at the radio access node.

14. A method according to claim 12, the received admission control information comprising one or more of: a forecast of resources that the radio access node predicts will be required to support the one or more admissions; information of maximum allowed resources available to the radio access node; information of unused resources available to the radio access node.

15. A method according to claim 12, the received admission control information comprising information of one or more measurements of resources consumed following admission.

16. A method according to claim 12, the processing the received admission control information comprising estimating one or more inaccuracies in admission control criteria of the radio access node.

17. A method according to claim 12, the instruction to modify admission control criteria of the radio access node comprising a command to make the admission control stricter or less strict.

18. A method according to claim 17, the command comprising a binary or N-ary counter.

19. A method according to claim 12, wherein the instruction to modify admission control criteria of the radio access node does not specify how the radio access node is to implement the modification.

20. A method according to claim 12, wherein the instruction to modify admission control criteria of the radio access node causes the radio access node to modify admission control criteria preconfigured in the radio access node.

21. A method according to claim 12, wherein the instruction to modify admission control criteria of the radio access node causes the radio access node to modify estimation criteria used for admission control by the radio access node.

22. A method according to claim 12, the processing the received admission control information comprising calculating one or more offsets.

23. A method according to claim 22, the one or more offsets comprising one or more of: a first offset for adjusting forecast values of the admission control criteria; a second offset for adjusting a level of allowed resources; a third offset for adjusting a level of available resources.

24. A computer program comprising program code adapted to perform the steps of claim 1 when the program is run on a data processing apparatus.

25. A computer program comprising program code moans adapted to perform the steps of claim 12 when the program is run on a data processing apparatus.

26. An apparatus comprising at least one processor, and at least one memory including computer program code, wherein the at least one memory and the computer program code are configured, with the at least one processor, to:
provide admission control information from the apparatus to a controller of the apparatus; and
in response to the providing admission control information, receive from the controller information comprising an instruction for the apparatus to modify admission control criteria of the apparatus; and
modify the admission control criteria in response to the instruction.

27. An apparatus comprising at least one processor, and at least one memory including computer program code, wherein the at least one memory and the computer program code are configured, with the at least one processor, to:
receive at the apparatus admission control information from a radio access node;
process the received admission control information at the apparatus; and
send to the radio access node information comprising an instruction for the radio access node to modify admission control criteria of the radio access node, based on the processed admission control information.
